(19) United States
(12) Patent Application Publication
(10) Pub. No.: US 2009/0010458 A1
(43) Pub. Date: Jan. 8, 2009

(54) Wireless transmitter and microphone based communications system

(75) Inventor: Ming-Cheng Chung, Taichung (TW)

Correspondence Address: BACON & THOMAS, PLLC, 625 SLATERS LANE, FOURTH FLOOR, ALEXANDRIA, VA, 22314-1176, US

(73) Assignee: JTS PROFESSIONAL CO., LTD., Taichung (TW)

(21) Appl. No.: 11/822,480

(22) Filed: Jul. 6, 2007

(51) Int. Cl. H04R 3/00

(52) U.S. Cl. 381/122

(57) ABSTRACT

In one embodiment a communications system includes at least one wireless microphone and a wireless transmitter which is adapted to send data to each microphone after setting a common operating frequency and ID. A PC having a wireless communications module is provided in another embodiment. The PC is adapted to activate the transmitter to send data to each microphone through its communications module.

### BACKGROUND OF THE INVENTION

1. Field of Invention

The invention relates to wireless communications system and more particularly to such a system comprising at least one wireless microphone, and a wireless transmitter which is adapted to send data to each microphone after setting a common operating frequency and ID.

2. Description of Related Art

Typically, electrical devices including microphones and stereos are connected to wall outlets in a room of a KTV center. One drawback is that wires may get tangled.

Still typically, as an improvement of the above arrangement, the microphones are replaced with wireless ones. Also, one or more controllers are provided in which each controller is adapted to control two wireless microphones. Thus, for example, three controllers are required to control six wireless microphones. This inevitably will increase operating cost greatly. Thus, the need for improvement still exists.

### SUMMARY OF THE INVENTION

It is therefore one object of the invention to provide a communications system comprising at least one wireless microphone, and a wireless transmitter which is adapted to send data to each microphone after setting a common operating frequency and ID.

The above and other objects, features and advantages of the invention will become apparent from the following detailed description taken with the accompanying drawings.

### BRIEF DESCRIPTION OF THE DRAWINGS

FIG. 1 is a block diagram of a first preferred embodiment of communications system according to the invention; and

FIG. 2 is a block diagram of a second preferred embodiment of communications system according to the invention.

### DETAILED DESCRIPTION OF THE INVENTION

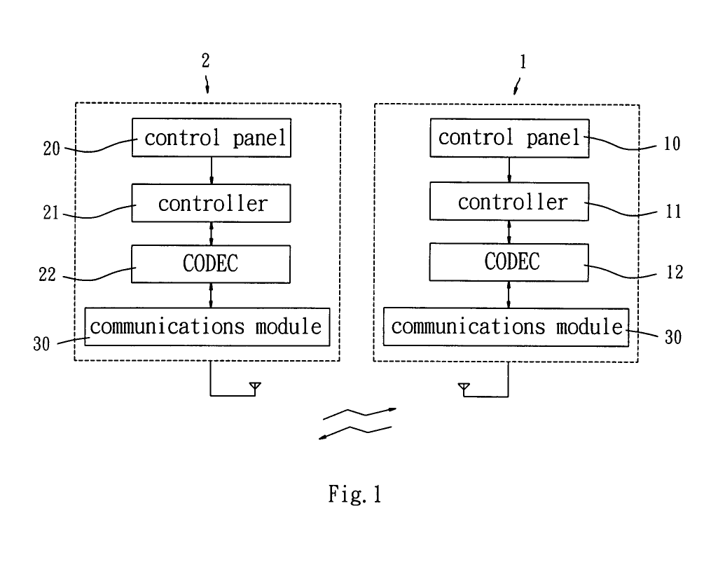

Referring to FIG. 1, a communications system in accordance with a first preferred embodiment of the invention is shown. The system comprises a wireless microphone 1 and a wireless transmitter 2. Each component is discussed in detailed below.

The microphone 1 comprises a control panel 10, a controller 11 on the control panel 10 for setting a channel, transmission power, and a transmission range, a codec (coder-decoder) 12 in the control panel 10, a communications module 30 in the control panel 10; and an antenna (not numbered) extending out of the housing of the microphone 1.

Likewise, the transmitter 2 comprises a control panel 20, a controller 21 on the control panel 20 for setting a channel, transmission power, and a transmission range, a codec 22 in the control panel 20, a communications module 30 in the control panel 20, and an antenna (not numbered) extending out of the housing of the transmitter 2.

Each communications module 30 includes circuitry and is complied with the specifications of IEEE 802.15.4. Also, the communications module 30 in the transmitter 2 is adapted to send data at a rate of at least 200 kbit/s over WPAN (wireless personal area network).

Moreover, the controller 21 can set an operating frequency and an identification (ID) of each of the transmitter 2 and the microphone 1 such that data can be sent from the transmitter 2 to the microphone 1 as detailed later.

For example, in an exemplary operation, data is first encoded with an ID by the codec 22 in which the ID is set by the controller 21. Next, the encoded data is sent to the communications module 30. Next, the communications module 30 sends the data to the antenna of the transmitter 2 which in turn sends radio waves containing the data to the antenna of the microphone 1 for receiving. The received data is then sent to the communications module 30 of the microphone 1. The communications module 30 of the microphone 1 in turn sends same to the codec 12 for decoding. Next, the decoded data is sent to the controller 11 for processing. In detail, the controller 11 determines whether ID of the received data to be valid or not by comparing the ID of the received data with an ID of the controller 11 in which the ID of the controller 11 is also set by the transmitter 2. The controller 11 then processes the received data accordingly if the comparison result is true.

It is noted that a single transmitter 2 can control a plurality of microphones 1 wirelessly. Thus, operating cost is great reduced. Moreover, heat generated by the wireless transmitter 1 can be effectively dissipated.

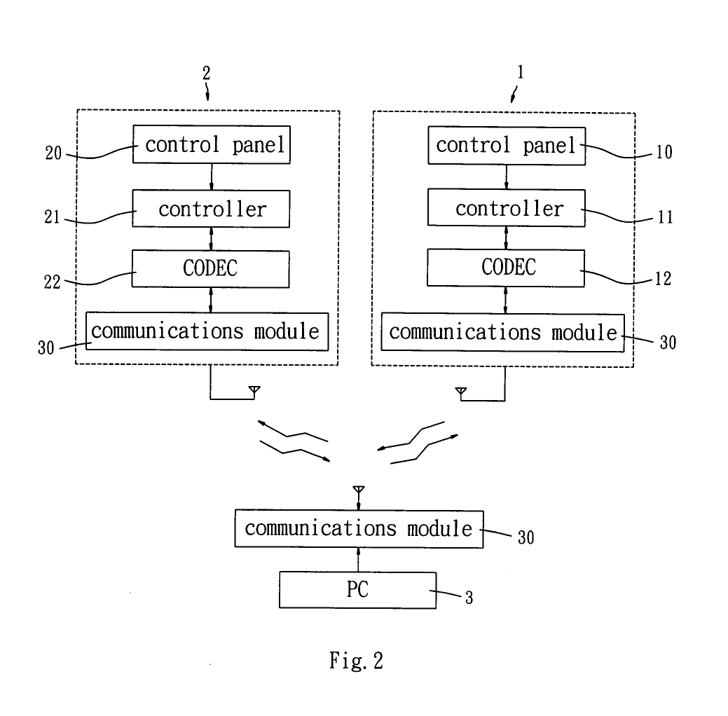

Referring to FIG. 2, a communications system in accordance with a second preferred embodiment of the invention is shown. The characteristics of the second preferred embodiment are detailed below. A PC 3 having a communications module 30 is provided. The communications module 30 is also complied with the specifications of IEEE 802.15.4. A user can run software in the PC 3 to operate the communications module 30 which in turn activates the data sending mechanism of the transmitter 2 described above. Moreover, a WPAN can be established by wirelessly connecting the wireless transmitter 2, one or more wireless microphones 1, the PC 3 together.

Alternatively, the PC 3 can be replaced by a PDA (Personal Digital Assistant) in the other embodiments.

Each embodiment can prevent two microphones from operating in the same operating frequency. Otherwise, interference can occur.

In addition, a user can operate either the controller 21 of the transmitter 2 or the PC 3 to remotely locate and eliminate the source of trouble occurred in any microphone 1. Further, either the controller 21 of the transmitter 2 or the PC 3 can reset the operating frequencies of the microphones 1 for maintaining quality of the microphones.

While the invention herein disclosed has been described by means of specific embodiments, numerous modifications and variations could be made thereto by those skilled in the art without departing from the scope and spirit of the invention set forth in the claims.

What is claimed is:

1. A communications system comprising:
at least one wireless microphone each including a first control panel, a first controller on the first control panel, a first codec (coder-decoder) in the first control panel, a first communications module in the first control panel, and a first antenna; and
a wireless transmitter including a second control panel, a second controller on the second control panel for setting an operating frequency and an ID (identification) thereof and an operating frequency and an ID of each microphone, a second codec in the second control panel, a second communications module in the second control panel, and a second antenna,
wherein in a communications operation in the transmitter data is encoded with an ID by the second codec, the encoded data is sent to the second communications module, the second communications module sends the encoded data to the second antenna, and the second antenna sends radio waves containing the encoded data, in each microphone the first antenna receives and sends the encoded data to the first communications module, the first communications module sends the encoded data to the first codec for decoding, and the decoded data is sent to the first controller, and the first controller is adapted to determine whether the ID of the decoded data is valid or not by comparing the ID of the decoded data with an ID of the microphone.

2. The communications system of claim 1, further comprising a personal computer (PC) including a third communications module and a third antenna, and wherein the PC is adapted to activate the transmitter to send data to each microphone through the third communications module.
